(19) United States
(12) Patent Application Publication
(10) Pub. No.: US 2026/0368301 A1
(43) Pub. Date: Nov. 19, 2026

(54) System and Method for Dynamically Learning and Updating Authentication Policies Based on Outcome Feedback

(71) Applicant: Insoo Kim, Paju-si (KR)

(72) Inventor: Insoo Kim, Paju-si (KR)

(21) Appl. No.: 19/576,193

(22) Filed: Mar. 24, 2026

Related U.S. Application Data
(63) Continuation of application No. 19/428,119, filed on Dec. 20, 2025.

(30) Foreign Application Priority Data
Apr. 1, 2025 (KR) 10-2025-0042456

(51) Int. Cl. G06F 21/42; H04L 9/32

(52) U.S. Cl. CPC G06F 21/42; H04L 9/3228

(57) ABSTRACT

An adaptive authentication system dynamically learns and updates authentication policies based on outcome feedback. The system receives an authentication request and collects context metadata including device, network, location, or behavioral information. A normalized risk score is generated based on the context metadata, and an authentication policy including OTP-related parameters is applied based on the risk score. Authentication outcome data is collected and analyzed together with historical authentication patterns to identify anomalies or attack patterns. The historical authentication patterns are updated based on the outcome data, and the authentication policy is dynamically adjusted for subsequent authentication requests. The system continuously improves authentication performance and security through feedback-driven policy optimization.

### 2. CROSS-REFERENCE TO RELATED APPLICATION

This application is a continuation of U.S. patent application Ser. No. 19/428,119, filed on Dec. 20, 2025, which claims priority to and the benefit of Korean Patent Application No. 10-2025-0042456, filed on Apr. 1, 2025, the entire contents of which are incorporated herein by reference.

### 3. FIELD OF THE INVENTION

The present invention relates to user authentication systems, and more particularly, to an adaptive two-factor authentication (2FA) system and method that dynamically generates one-time passwords (OTPs) based on real-time risk assessment using artificial intelligence (AI), and delivers the OTP through an independent out-of-band (OOB) channel to enhance security and resilience against cyberattacks.

### 4. BACKGROUND OF THE INVENTION

Conventional OTP-based 2FA systems typically rely on static six-digit numeric OTPs, which do not reflect contextual risk factors of the login environment. Such systems are vulnerable to phishing, man-in-the-middle (MitM) attacks, and session hijacking. Moreover, in most existing systems, the OTP is generated and transmitted through the same in-band channel as the login request, making it susceptible to interception.

Risk-based authentication (RBA) has been introduced to assess login contexts; however, existing RBA systems generally adjust authentication requirements (e.g., challenge vs. no challenge) without dynamically modifying the OTP itself. Thus, there is a need for a system that adaptively adjusts the OTP properties according to real-time risk assessment, while transmitting OTPs via physically and logically isolated channels for improved security.

### 5. SUMMARY OF THE INVENTION

The invention provides an adaptive authentication system comprising:
a machine-learning-based risk assessment engine that computes a real-time risk score from contextual metadata,
an OTP policy decision module that dynamically adjusts OTP properties (length, character set, validity period, delivery channels) according to the risk score, and
an out-of-band OTP generation and transmission module, isolated from the primary authentication server, which delivers OTPs through secure multi-channel communication.

The invention improves security by:
dynamically strengthening OTPs under high-risk conditions,
mitigating phishing and MitM attacks through OOB delivery,
enabling administrator alerts for rapid incident response.

### 6. ABBREVIATIONS AND DEFINITIONS

As used herein, the following terms have the meanings indicated.
out-of-band (OOB): a communication path that is physically and logically isolated from the primary authentication channel/server.
one-time password (OTP): a single-use authentication code whose properties may be dynamically adjusted.
time-to-live (TTL): the validity period of an OTP.
risk-based authentication (RBA): authentication behavior that adapts to a computed risk score.
machine-learning (ML) model: a trained classifier used to compute the risk score from a feature vector.
feature vector: a structured representation of contextual metadata, which may include normalized or encoded IP address ranges, device and browser fingerprints, coarse geolocation buckets, temporal features, and historical behavior aggregates.

### 7. BRIEF DESCRIPTION OF THE DRAWINGS

FIG. 1 illustrates a system architecture of the adaptive two-factor authentication system, including a user device, contextual data collection module, risk assessment engine, risk assessment module, OTP policy decision module, OTP generation server (out-of-band), and mobile application. The system includes a user device (101), login terminal (102), contextual data collection module (103), machine-learning-based risk assessment engine (104), risk assessment module (105), OTP policy decision module (106), independent OTP generation server (OOB) (107), and mobile application (108).

Feature Vector Preprocessing. In certain embodiments, the contextual metadata collected by the contextual data collection module (103) is preprocessed and converted into a structured feature vector for input to the machine-learning model of the risk assessment engine (104). The feature vector may include normalized and encoded representations of IP address ranges, device and browser fingerprints, coarse geolocation buckets (e.g., country/region), temporal features (e.g., hour-of-day, day-of-week), and historical behavior aggregates. The risk assessment module (105) consumes the model output and normalizes the risk score to a value between 0.0 and 1.0 for use by the OTP policy decision module.

TABLE 1
Components and Functions of the Adaptive Authentication System

| | | | Notes |
|---|---|---|---|
| Reference | | | (installation, |
| No. | Component | Function | communication, etc.) |
| 101 | User device | Initiates login request and | End user in web or mobile |
| | | enters OTP for authentication | environment |
| 102 | Login terminal | Device through which the user | PC, smartphone, kiosk, or |
| | | submits login requests and | client device |
| | | inputs OTP | |
| 103 | Contextual data | Collects and preprocesses | Located on login server or |
| | collection module | metadata (IP, time, device info, | proxy gateway |
| | | etc.) for risk assessment | |
| 104 | Machine-learning- | Performs risk prediction using | Implemented as Random |
| | based risk assessment | collected metadata and a trained | Forest, XGBoost, etc. |
| | engine | ML model | |
| 105 | Risk assessment | Computes normalized risk score | Integrated with OTP policy |
| | module | (0.0-1.0) for OTP policy | logic |
| | | adjustment | |
| 106 | OTP policy decision | Dynamically determines OTP | Executes thresholded rules |
| | module | attributes based on the risk | and lookup tables; outputs a |
| | | score | signed policy token |
| | | | consumed by the Independent |
| | | | OTP generation server |
| | | | (OOB) (107). |
| 107 | Independent OTP | Dynamically generates OTP | Operated on an independent |
| | generation server | based on risk score and delivers | server, physically/logically |
| | (OOB) | via out-of-band channels | isolated from the primary |
| | | | authentication server |
| 108 | Mobile application | Receives and displays OTP to | Receives via OOB channels |
| | | user, guides OTP entry | on user's smartphone |

FIG. 2 is a flowchart depicting the process of risk-based OTP property adjustment, OTP generation, and OOB transmission. The flowchart illustrates the sequence of operations performed by the adaptive two-factor authentication system. In particular, the process proceeds as follows:
1. User login request is submitted from a client device.
2. Login server collects contextual metadata (e.g., IP address, device profile, time, location) and forwards it to the risk assessment. During step 2, the system generates a feature vector from the collected metadata and provides the feature vector as input to the trained machine-learning classifier to compute the risk score.
3. Risk assessment engine computes a risk score using a trained machine-learning model.
4. OTP policy decision module determines OTP properties (length, character set, validity period, transmission channel, administrator alert) according to the computed risk score.
5. Validity Period Examples. By way of example, under high-risk conditions the OTP validity period may be set to less than 30 seconds (e.g., 20-30 s), whereas under low-risk conditions it may be about 60 seconds. The policy may further map intermediate risk bands to intermediate validity periods (e.g., 30-45 s).
6. OTP generation server (out-of-band) generates the OTP and transmits it via selected out-of-band (OOB) channels (e.g., mobile application, email, administrator alert).
7. User enters OTP into the login interface.
8. Primary authentication server validates the OTP and completes the authentication process.

### 8. DETAILED DESCRIPTION OF THE PREFERRED EMBODIMENTS

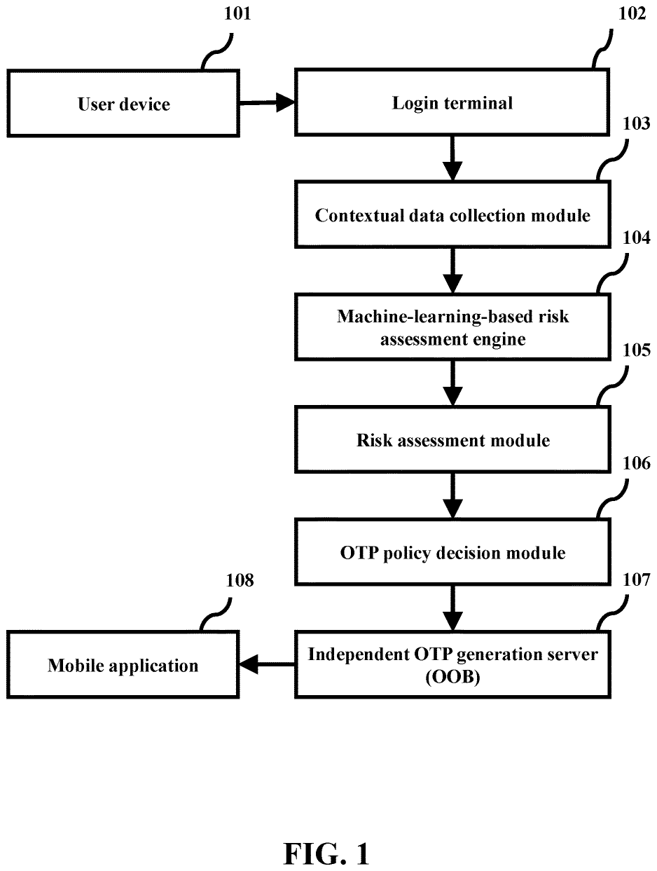

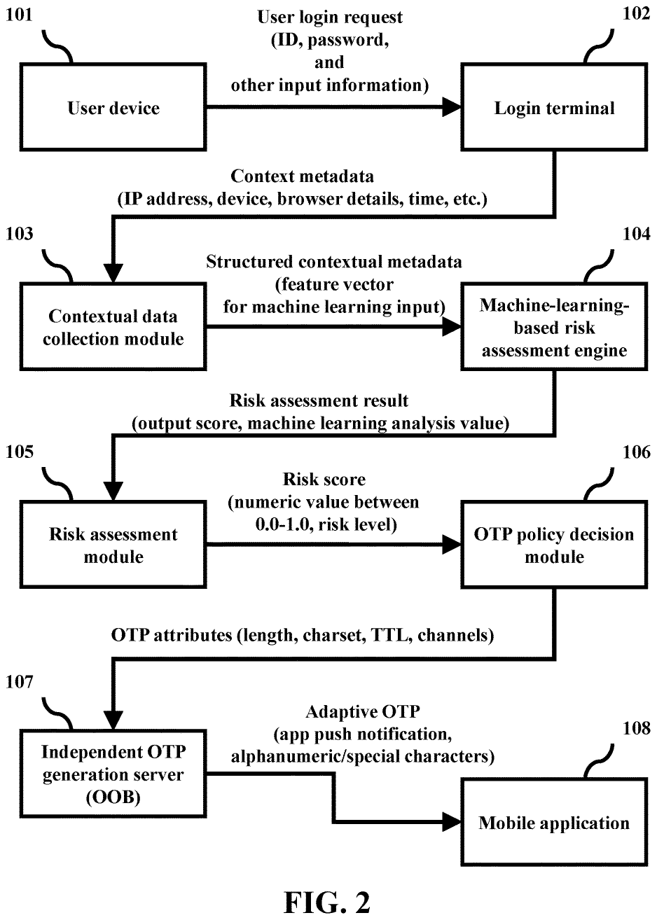

### System Architecture (FIG. 1)

The adaptive authentication system includes:
User Device (101): Generates login requests and receives OTP input.
Login Terminal (102): Client interface where the login is initiated.
Contextual Data Collection Module (103): Collects metadata such as IP address, device information, time, and geolocation.
Machine-Learning-Based Risk Assessment Engine (104): Employs a trained machine-learning classifier (e.g., Random Forest, Gradient Boosting) to evaluate the legitimacy of login requests.
Risk Assessment Module (105): Produces a normalized risk score (0.0-1.0) that serves as the basis for OTP policy adjustment.
OTP Policy Decision Logic. Given a risk score r in [0, 1], the system selects (length, charset, TTL, channels) by evaluating thresholded rules and lookup tables stored in the OTP policy decision module. The module executes on dedicated server-side processes and outputs a signed policy token that is consumed by the OTP generation server (OOB) to generate and deliver the OTP according to the determined attributes.
OTP Policy Decision Module (106): Dynamically determines OTP attributes, including length, character set, validity period (TTL), number and type of out-of-band channels, and whether to trigger an administrator alert, based on the normalized risk score by evaluating thresholded rules and lookup tables, and outputs a signed policy token consumed by the OTP generation server (OOB).
Independent OTP Generation Server (107): Generates OTPs according to dynamic policies and transmits them through out-of-band channels, independent of the primary authentication server.
Mobile Application (108): Receives OTPs and guides the user to complete the login process.

### Method of Operation (FIG. 2)

1. A login request is received from the user device.
2. Metadata is collected and forwarded to the risk assessment engine.
3. The risk assessment engine computes a risk score.
4. The OTP policy decision module adjusts OTP properties (e.g., extending OTP length, including alphanumeric and special characters, reducing validity period).
   Risk-to-Policy Mapping Examples. In one implementation, the policy maps normalized risk-score bands to OTP attributes as follows: 0.0-0.3 (a range from 0.0 to 0.3)->6-8 digits, alphanumeric, TTL about 60 s, single channel; 0.3-0.6 (a range from 0.3 to 0.6)->8-10 characters, alphanumeric with at least one special character, TTL 30-45 s, one or two channels; >=0.6 (0.6 or greater)->>=10 (10 or more) characters including digits, mixed case and special characters, TTL 20-30 s, multiple channels with an administrator alert.
5. The OTP generation server (out-of-band) generates the OTP and transmits it via selected out-of-band channels (e.g., mobile application, email, administrator alert).
   OOB Transport Details. The OTP generation server (OOB) communicates over mutually authenticated TLS, attaches a per-message nonce and expiration timestamp to prevent replay, and enforces idempotent delivery via message identifiers across mobile application and email channels.
6. The user inputs the OTP for verification, and the system authenticates the login.

### Experimental Validation

In experimental testing with 5,000 login attempts, the proposed system reduced phishing success rates from 82% (static OTP) to 14%, and rendered brute-force attacks infeasible due to increased complexity and shortened OTP validity.

1. A method for dynamically controlling authentication, comprising:
receiving, by an adaptive authentication system, an authentication request associated with a user;
collecting context metadata including at least one of device information, network information, location information, or behavioral data;
generating a normalized risk score based on the context metadata;
applying an authentication policy including OTP-related parameters based on the normalized risk score;
receiving authentication outcome data corresponding to the authentication request;
analyzing the authentication outcome data and historical authentication patterns to identify at least one of an anomaly or an attack pattern;
updating the historical authentication patterns based on the authentication outcome data; and
adjusting the authentication policy for subsequent authentication requests based on the updated historical authentication patterns.

2. An adaptive two-factor authentication system, comprising:
one or more processors; and
a memory storing instructions that, when executed, cause the one or more processors to:
receive an authentication request associated with a user;
collect context metadata including at least one of device information, network information, location information, or behavioral data;
generate a normalized risk score based on the context metadata;
apply an authentication policy including one or more parameters determined based on the normalized risk score;
receive authentication outcome data corresponding to the authentication request;
analyze the authentication outcome data and historical authentication patterns to detect at least one of an anomaly or an attack pattern;
compute one or more performance metrics to update a risk-to-policy mapping based on the authentication outcome data; and
update the authentication policy based on at least one of the performance metrics, detected anomalies, or detected attack patterns;
wherein the adaptive two-factor authentication system is configured to dynamically adapt the authentication policy in real-time based on the authentication outcome data.

3. A non-transitory computer-readable medium storing instructions that, when executed by one or more processors, cause an adaptive two-factor authentication system to:
perform authentication using an authentication policy having configurable parameters;
collect context metadata;
generate a normalized risk score based on the context metadata;
monitor authentication outcome data;
analyze the authentication outcome data and historical authentication patterns;
compute performance metrics based on the authentication outcome data; and
dynamically update the authentication policy based on the performance metrics to improve authentication performance and security.

4. The method of claim 1, wherein the context metadata includes biometric authentication results.

5. The method of claim 1, wherein the context metadata includes device fingerprint data.

6. The method of claim 1, wherein the normalized risk score is dynamically updated in real-time.

7. The method of claim 1, wherein the authentication policy includes selection of multiple out-of-band (OOB) communication channels.

8. The method of claim 1, wherein detecting the attack pattern includes detecting repeated authentication failures exceeding a threshold to trigger an administrator alert.

9. The method of claim 1, wherein updating the authentication policy includes restricting or blocking authentication attempts in response to the normalized risk score exceeding a threshold.

10. The method of claim 1, wherein updating the authentication policy includes adjusting at least one of a validity period (Time-To-Live), a retry limit, or an out-of-band (OOB) communication channel.

11. The method of claim 1, wherein the authentication policy is individualized per user or per device based on the historical authentication patterns.

12. The method of claim 1, wherein the authentication policy is updated in real-time based on the authentication outcome data.
